(19) United States
(12) Patent Application Publication
(10) Pub. No.: US 2019/0114050 A1
(43) Pub. Date: Apr. 18, 2019

(54) DISPLAY DEVICE, DISPLAY CONTROL METHOD, AND DISPLAY CONTROL PROGRAM

(71) Applicant: FUJITSU CONNECTED TECHNOLOGIES LIMITED, Kawasaki-shi (JP)

(72) Inventors: Satoshi Takahashi, Yokohama (JP); Tetsuya Murata, Kawasaki (JP); Takanori Harada, Kawasaki (JP)

(73) Assignee: FUJITSU CONNECTED TECHNOLOGIES LIMITED, Kawasaki-shi (JP)

(21) Appl. No.: 16/155,075

(22) Filed: Oct. 9, 2018

(30) Foreign Application Priority Data
Oct. 12, 2017 (JP) 2017-198210

(51) Int. Cl. G06F 3/0489; G06F 3/0484; H04M 1/725

(52) U.S. Cl. CPC G06F 3/0489; H04M 1/72583; H04M 1/72561; G06F 3/04845

(57) ABSTRACT

A display device includes an input unit that receives input of two-dimensional information, a display that displays a screen and a control unit. When determining that one of a plurality of blocks into which the screen is two-dimensionally divided is selected based on a one-dimensional component of the information received by the input unit, the control unit magnifies and displays the selected block on the display with a first magnification factor which allows visual recognition of remaining blocks none of which has been selected. When detecting decision to magnify the selected block, the control unit magnifies and displays the selected block on the display with a second magnification factor larger than the first magnification factor.

### CROSS-REFERENCE TO RELATED APPLICATION

This application is based upon and claims the benefit of priority of the prior Japanese Patent Application No. 2017-198210, filed on Oct. 12, 2017, the entire contents of which are incorporated herein by reference.

### FIELD

The embodiments discussed herein are related to a display device, a display control method, and a display control program.

### BACKGROUND

A technique has been proposed to make an operation to magnify part of an image intuitively understandable when the image is displayed on a device having a small display screen, such as a mobile phone. In particular, in the technique, partial images obtained by dividing an image are disposed in the same positional relationship as that of operation keys of the device, when an operation key is operated, a partial image in the same positional relationship is magnified and displayed (see, for example, Patent Document 1).

### DOCUMENTS OF RELATED ARTS

### Patent Documents

[Patent Document 1] Japanese Laid-open Patent Publication No. 2003-273971

### SUMMARY

According to an aspect of the embodiments, a display device includes an input unit that receives input of two-dimensional information, a display that displays a screen and a control unit. When determining that one of a plurality of blocks into which the screen is two-dimensionally divided is selected based on a one-dimensional component of the information received by the input unit, the control unit magnifies and displays the selected block on the display with a first magnification factor which allows visual recognition of remaining blocks none of which has been selected. When detecting decision to magnify the selected block, the control unit magnifies and displays the selected block on the display with a second magnification factor larger than the first magnification factor.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1A is an example front view of a display device. FIG. 1B is an example right-side view of the display device.

FIG. 2 is a hardware configuration example of the display device.

FIG. 3A is an example functional block diagram of the display device. FIG. 3B is an example of movement of a finger to an input unit.

FIG. 4 is a flowchart illustrating an example operation of the display device.

FIGS. 5A to 5E are views and graphs for explaining the operation to magnify part of a screen with a first magnification factor.

FIG. 6A is a view for explaining an example of division of a screen. FIG. 6B is an example of forward selection order information. FIG. 6C is a screen example in which part of a screen is magnified with the first magnification factor.

FIG. 7A is an operation example (part 1). FIG. 7B is a screen transition example (part 1).

FIG. 8A is an operation example (part 2). FIG. 8B is a screen transition example (part 2).

FIGS. 9A to 9C are each another example of forward selection order information.

FIGS. 10A to 10D are each another example of backward selection order information.

FIG. 11A is backward selection order information. FIG. 11B to 111 are each a screen example displayed on a display.

FIG. 12A is a flowchart illustrating an example operation of the display device. FIG. 12B is an example magnification start position determination table.

### DESCRIPTION OF EMBODIMENTS

In the above-described technique, multiple operation keys corresponding to the number of divided partial mages have to be disposed in the device, and a problem arises that with one operation key for instance, it is not possible to magnify and display a partial image which is not in the same positional relationship as that of the operation key.

Thus, in an aspect, it is aimed to provide a display device, a display control method, and a display control program that are capable of improving the operability in designating a magnification target range. It is possible to improve the operability in designating a magnification target range.

Hereinafter, an embodiment for carrying out the present disclosure will be described with reference to the drawings.

### First Embodiment

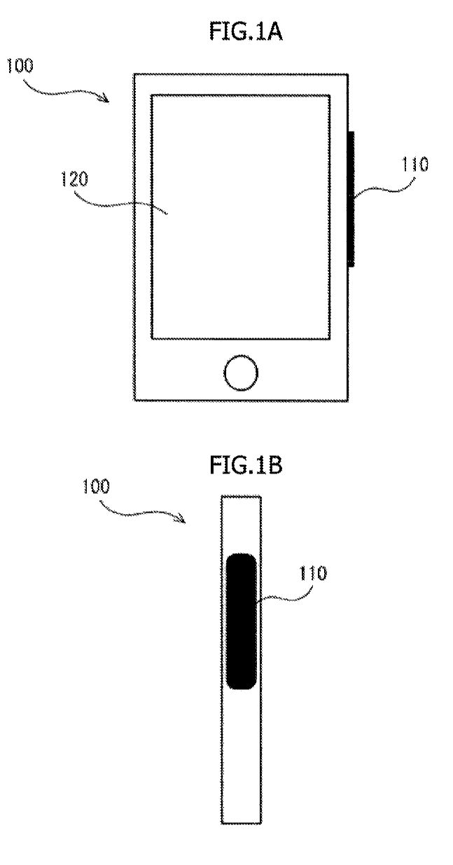

FIG. 1A is an example front view of a display device 100. FIG. 1B is an example right-side view of the display device 100. Although FIGS. 1A and 1B illustrate a smartphone as an example of the display device 100, for instance, a wearable terminal (for instance, a smartwatch), a tablet terminal, or a display terminal having no communication function may serve as the display device 100.

As illustrated in FIGS. 1A and 1B, the display device 100 includes an input unit 110 and a display 120. The input unit 110 is provided on the right-side surface of the display device 100, and the display 120 is provided on the front surface of the display device 100. It is to be noted that the input unit 110 may be provided on any one of the left-side surface, the top surface, the bottom surface, the back surface, and the front surface of the display device 100. Although the details will be described later, the input unit 110 is capable of detecting contact with a target for detection and two-dimensional movement of a target for detection. The target for detection may be, for instance, a finger of a user who utilizes the display device 100. However, as long as contact with the target for detection and two-dimensional movement of the target for detection are detectable, the target for detection may be, for instance, a touch pen and is not limited to a finger of a user. Meanwhile, the display 120 displays various screens such as a screen with a portion magnified.

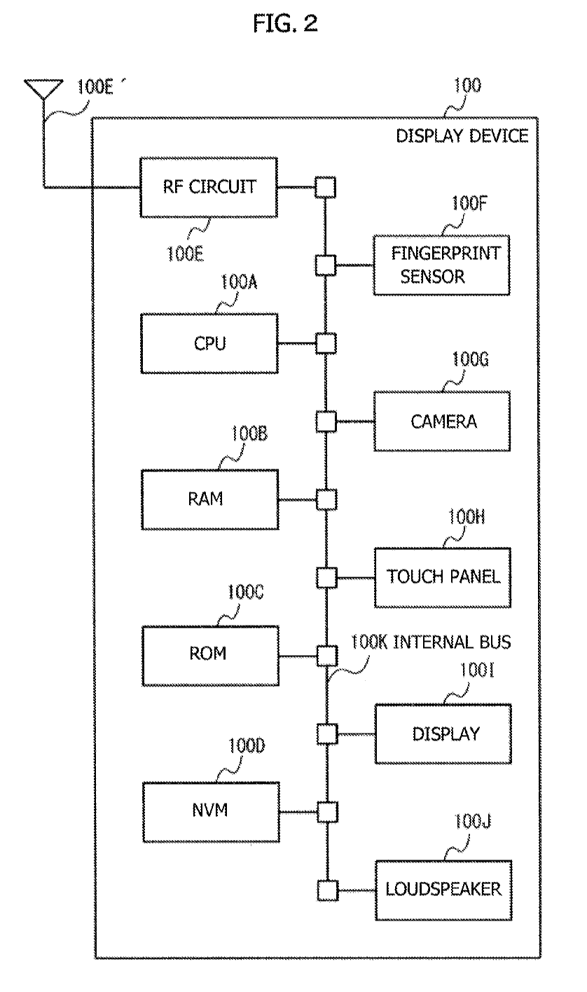

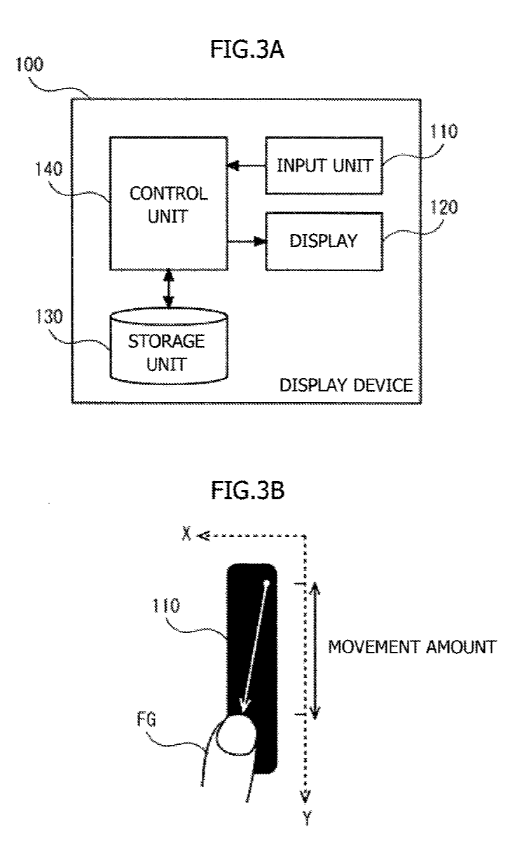

Hereinafter, the configuration of the display device 100 will be described in detail with reference to FIGS. 2, 3A and 3B.

FIG. 2 is a hardware configuration example of the display device 100. As illustrated in FIG. 2, the display device 100 includes a central processing unit (CPU) 100A as a hardware processor, a random access memory (RAM) 100B, a read only memory (ROM) 100C, and a non-volatile memory (NVM) 100D. In addition, the display device 100 includes a fingerprint sensor 100F, a touch panel 100H, and a display 100I. It is to be noted that instead of the fingerprint sensor 100F, the display device 100 may include a two-dimensional input device corresponding to the fingerprint sensor 100F.

The display device 100 may include a radio frequency (RF) circuit 100E, a camera 100G, and a loudspeaker 100J as appropriate. An antenna 100E′ is connected to the RF circuit 100E. Instead of the RF circuit 100E, a CPU (not illustrated) that implements a communication function may be utilized. The CPU 100A to the loudspeaker 100J are coupled to each other via an internal bus 100K. At least the CPU 100A and the RAM 100B collaborate together, thereby implementing a computer. It is to be noted that instead of the CPU 100A, a micro processing unit (MPU) may be utilized as a hardware processor.

In the above-mentioned RAM 100B, a program stored in the ROM 100C or the NVM 100D is stored by the CPU 100A. The CPU 100A implements the later-described various functions by executing the stored program, and performs the later-described various types of processing. It is sufficient that the program comply with the later-described flowchart.

FIG. 3A is an example functional block diagram of the display device 100. Particularly, FIG. 3A illustrates relevant units of the functions implemented by the display device 100. FIG. 3B is an example of movement of a finger FG to the input unit 110. As illustrated in FIG. 3A, the display device 100 includes a storage unit 130 and a control unit 140 in addition to the input unit 110 and the display 120 described above.

Here, the input unit 110 may be implemented the fingerprint sensor 100F mentioned above. The display 120 may be implemented by the display 100I mentioned above. The storage unit 130 may be implemented by the NVM 100D mentioned above. The control unit 140 may be implemented by the CPU 100A mentioned above.

When a target for detection is the finger FG of a user, the input unit 110 detects contact of the finger FG and two-dimensional movement of the finger FG. When detecting contact of the finger FG, the input unit 110 reads the fingerprint of the finger FG, generates an image (hereinafter referred to as a fingerprint image) corresponding to the read fingerprint, and outputs the image to the control unit 140. When detecting two-dimensional movement of the finger FG, the input unit 110 outputs movement information indicating the two-dimensional movement to the control unit 140. Specifically, as illustrated in FIG. 3B, when the finger FG moves from a starting point of movement in a direction including x component and y component, the input unit 110 detects the movement, and outputs movement amount information including x-component of the movement amount and y-component of the movement amount to the control unit 140.

The display 120 displays various screens. More particularly, the display 120 displays a screen in which part of the screen is magnified with a first magnification factor (for instance, 130%) or a second magnification factor (for instance, 220%) greater than the first magnification factor, based on screen information and the control by the control unit 140. Desirably, the display 120 displays a screen in which part of the screen is magnified to a size covering the entire display area. In addition, the display 120 displays the original screen before being magnified, based on the screen information and the control by the control unit 140. In addition to the above-mentioned program, the storage unit 130 stores movement order information that specifies the order of movement when a magnification target range or a magnification target area (hereinafter simply referred to as a magnification target range) within a screen is moved. The movement order information includes forward movement order information and backward movement order information. In addition, the storage unit 130 stores image information indicating the above-mentioned fingerprint image, and image information indicating the original screen.

The control unit 140 controls the entire operation of the display device 100. For instance, when receiving two fingerprint images outputted from the input unit 110 at different timings within a threshold time, the control unit 140 compares the two fingerprint images. The control unit 140 may receive a fingerprint image via a double-tap operation described later. When the control unit 140 determines that a degree of similarity between the two fingerprint images is greater than or equal to a threshold degree of similarity (for instance, 90% or greater), the control unit 140 outputs screen information to the display 120, the screen information for magnifying and displaying a magnification target range of the screen with the first magnification factor. At this point, the control unit 140 refers to the movement order information stored in the storage unit 130, and determines the position of the magnification target range. Although the details will be described late, the control unit 140 identifies the display starting point of the magnification target range from a movement order included in the movement order information, and magnifies and displays a magnification target range at a position corresponding to the identified display starting point.

It is to be noted that the control unit 140 may determine that a fingerprint image received first is similar to the fingerprint image pre-stored in the storage unit 130, then may compare the subsequently received fingerprint image and the fingerprint image received first. In other words, the control unit 140 may perform authentication processing to determine propriety of use of the display device 100 by utilizing the fingerprint image received first and the pre-stored fingerprint image.

Also, when receiving movement amount information outputted from the input unit 110, the control unit 140 extracts the y-component of the movement amount, and identifies the movement amount of the finger FG as illustrated in FIG. 3B. Instead of extracting the y-component of the movement amount, the x-component of the movement amount may be eliminated. When identifying the movement amount, the control unit 140 refers to the movement order information stored in the storage unit 130, and moves the magnification target range, which has been magnified and displayed with the first magnification factor, according to the movement amount in accordance with the movement order. When the control unit 140 determines that the input unit 110 has not detected contact of the finger FG, the control unit 140 magnifies and displays the magnification target range, which has been magnified and displayed with the first magnification factor, with the second magnification factor.

Furthermore, when repeatedly receiving contact outputted from the input unit 110, the control unit 140 determines whether or not contact has occurred twice at the same position within a threshold time, and when it is determined that contact has occurred twice at the same position within a threshold time, the control unit 140 determines that the contact is a double-tap operation. When receiving a double-tap operation, the control unit 140 outputs screen information indicating the original screen to the display 120. Consequently, the display 120 displays the previous screen with the first magnification factor and the second magnification factor.

Next, the operation of the display device 100 will be described.

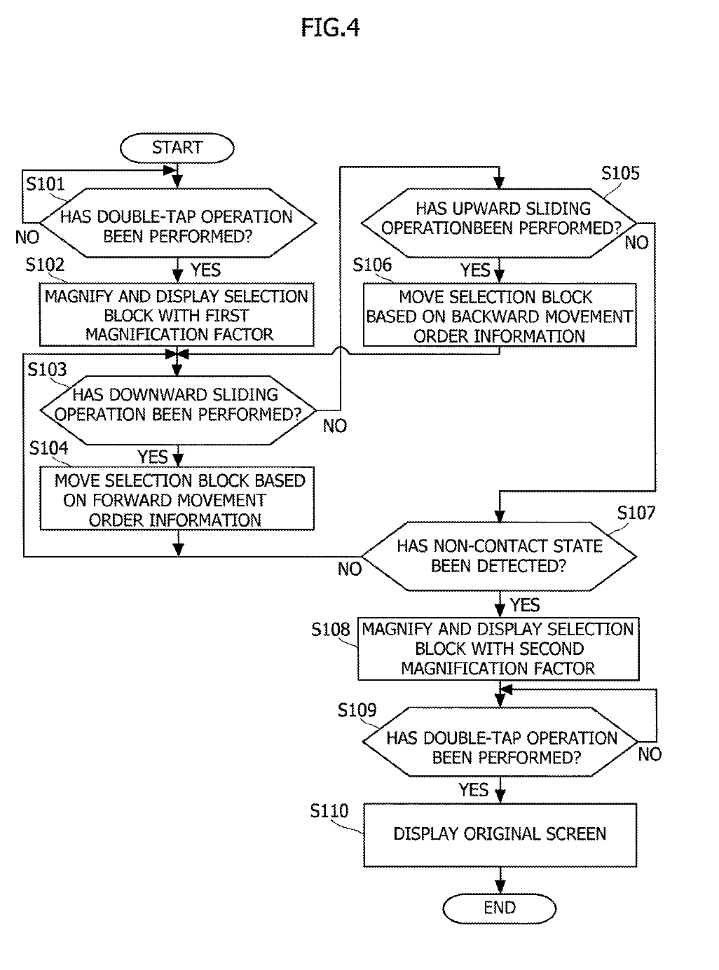

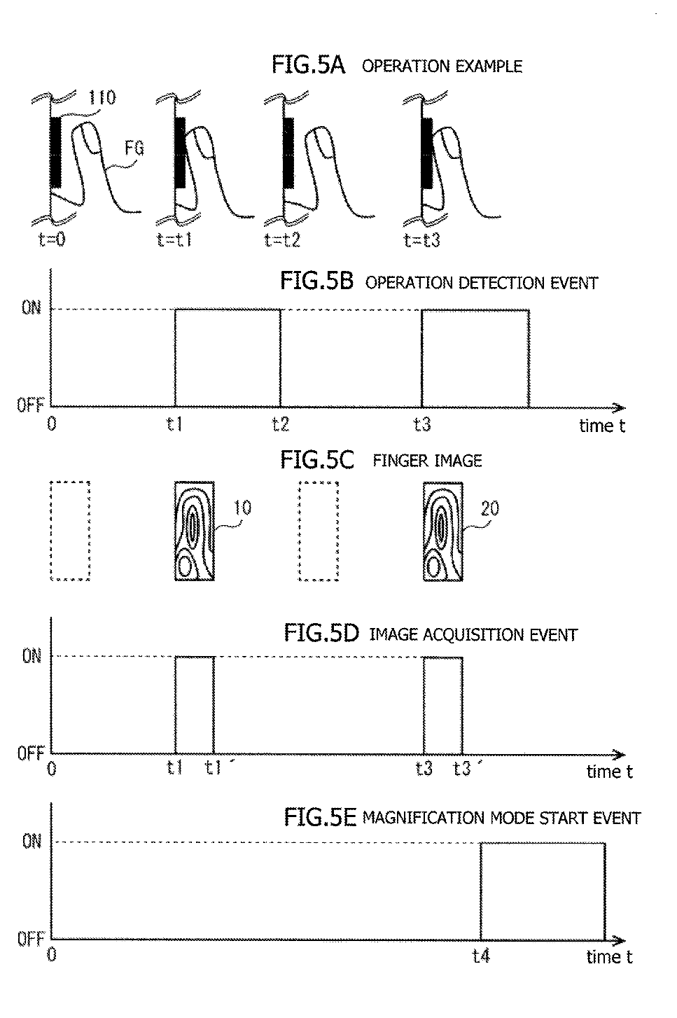

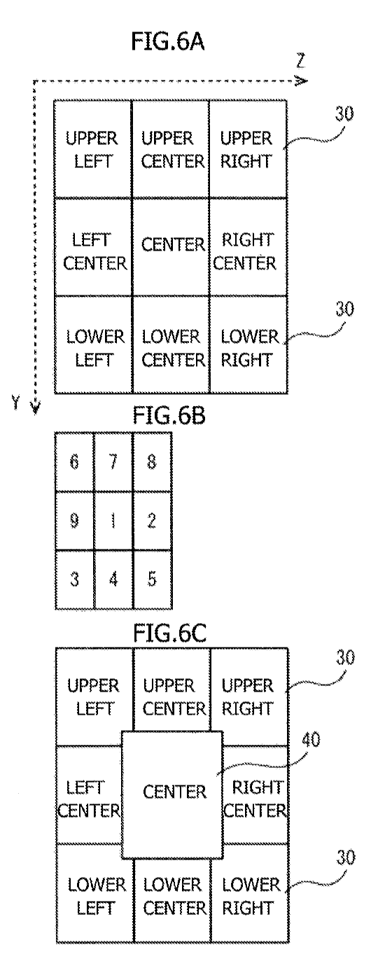

FIG. 4 is a flowchart illustrating an example operation of the display device 100. FIGS. 5A to 5E are views and graphs for explaining the operation to magnify a magnification target range of the screen with the first magnification factor. FIG. 6A is a view for explaining an example of division of the screen. FIG. 6B is an example of forward selection order information. FIG. 6C is a screen example in which a magnification target range of the screen is magnified with the first magnification factor.

First, as illustrated in FIG. 4, the control unit 140 stays in standby until a double-tap operation is performed on the input unit 110 (NO in step S101). When it is determined that a double-tap operation is performed on the input unit 110 (YES in step S101), the control unit 140 magnifies and displays a selection block with the first magnification factor (step S102). The details of the selection block will be described later.

For instance, as illustrated in FIG. 5A, when the finger FG is not in a contact with the input unit 110 from time t=0 to time t=t1 (which is referred to as a non-contact state as appropriate), as illustrated in FIG. 5B, the input unit 110 maintains an OFF state from time t=0 to time t=t1, the OFF state indicating that an operation to the input unit 110 has not been detected. Thus, as illustrated in FIG. 5C, the input unit 110 does not generate a fingerprint image, and the control unit 140 maintains the OFF state, in which an image acquisition event has not started, from time t=0 to time t=t1 as illustrated in FIG. 5D. In this manner, the control unit 140 stays in standby until a double-tap operation is performed on the input unit 110. It is to be noted that a dashed line rectangular frame in FIG. 5C indicates that the input unit 110 has not generated a fingerprint image.

On the other hand, as illustrated in FIG. 5A, when the finger FG is in a contact with the input unit 110 from time t=t1 to time t=t2 (which is referred to as a contact state as appropriate), as illustrated in FIG. 5B, the input unit 110 maintains an ON state from time t=t1 to time t=t2, the ON state indicating that an operation to the input unit 110 has been detected. Thus, as illustrated in FIG. 5C, the input unit 110 generates a fingerprint image 10, and the control unit 140 maintains the ON state, in which an image acquisition event has started, from time t=t1 to time t=t1′ as illustrated in FIG. 5D. It is to be noted that the input unit 110 has finished generating the fingerprint image 10 before time t=t2, thus the control unit 140 changes to OFF state at time t=t1′.

Furthermore, as illustrated in FIG. 5A, when the finger FG is separated from the input unit 110 and in a non-contact state from time t=t2 to time t=t3, as illustrated in FIG. 5B, the input unit 110 maintains the OFF state from time t=t2 to time t=t3. Thus, as illustrated in FIG. 5C, the input unit 110 does not generate a fingerprint image, and the control unit 140 maintains the OFF state from time t=t2 to time t=t3 as illustrated in FIG. 5D.

As illustrated in FIG. 5A, when the finger FG is in a contact state from time t=t3 within a threshold time from time t=t1 or time t=t2, as illustrated in FIG. 5B, the input unit 110 maintains the ON state from time t=t3. Thus, as illustrated in FIG. 5C, the input unit 110 generates a fingerprint image 20, and the control unit 140 maintains the ON state from time t=t3 to time t=t3′ as illustrated in FIG. 5D. When the input unit 110 finishes generating the fingerprint image 20, the control unit 140 compares the two fingerprint images 10, 20, and when it is determined that the degree of similarity between the two fingerprint images 10, 20 is greater than or equal to a threshold degree of similarity, the control unit 140 determines that a double-tap operation has been performed.

When determining that a double-tap operation has been performed, the control unit 140 subsequently magnifies and displays part of the screen with the first magnification factor. More particularly, when determining that a double-tap operation has been performed, as illustrated in FIG. 5E, the control unit 140 starts a magnification mode at time t=t4 of the determination. When starting the magnification mode, as illustrated in FIG. 6A, the control unit 140 divides the screen in two-dimensional directions: the Y-axis direction and the Z-axis direction. Specifically, the control unit 140 divides the screen in two-dimensional directions which are different from the two-dimensional directions for identifying the direction in which the finger FG moves. Hereinafter, multiple sections generated by dividing the screen are referred to as division blocks 30.

In this embodiment, the screen is divided into three parts in each of the Y-axis direction and the Z-axis direction to present nine division blocks 30. However, the number of division may be determined as appropriate according to the size of the display area of the display 120 and an increment (or a unit) of movement amount of the finger FG. For instance, the screen may be further finely divided by setting a smaller increment of movement amount of the finger FG. In each of the division blocks 30, identification information which identifies the position of the division block 30, such as “center” and “upper left” is indicated for the sake of convenience as illustrated in FIG. 6A.

When dividing the screen into multiple division blocks 30, the control unit 140 recognizes that one of the division blocks 30 is selected as a selection block based on the movement order information stored in the storage unit 130. For instance, when the storage unit 130 stores the forward movement order information illustrated in FIG. 6B, the control unit 140 recognizes that a division block 30 corresponding to identification information “center” is selected as a selection block, based on order information “1” indicating a starting point where an image is first magnified and displayed. It is to be noted that the order information “1” is equidistant from the positions of order information “3” and “8” or “5” and “6” located in the corners on the diagonal. When recognizing that one of the division blocks 30 is selected as a selection block, the control unit 140 magnifies and displays the selection block with the first magnification factor. Consequently, as illustrated in FIG. 6C, the selection block 40 magnified and displayed with the first magnification factor appears in the screen. In other words, the selection block 40 is selected as a magnification target range, and corresponds to the division block 30 which is magnified and displayed with the first magnification factor.

The reason why the movement order is determined as illustrated in FIG. 6B is that as a general tendency, advertisements are often disposed on the upper section of the screen in the Web screen layout, and are expected to be magnified and displayed less often. On the other hand, the beginning of a sentence of data text is often disposed on the central left side of the screen, and explanatory diagrams and images of the data text are often disposed in the center and on the central right side of the screen, and are expected to be magnified and displayed more often.

Returning to FIG. 4, when the processing in step S102 is completed, the control unit 140 then determines whether or not a downward sliding operation has been performed on the input unit 110 (step S103). When it is determined that a downward sliding operation has been performed on the input unit 110 (YES in step S103), the control unit 140 moves the selection block based on the forward movement order information (step S104).

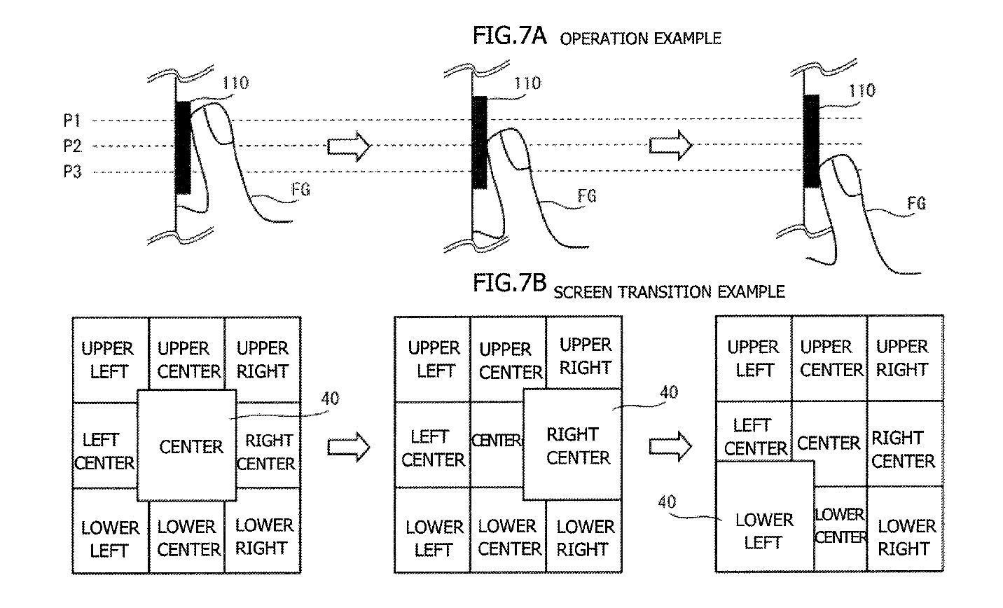

More particularly, when a sliding operation is performed down to a position P2 (specifically, in the positive Y-axis direction) on the input unit 110 as illustrated in the center of FIG. 7A with the finger FG in contact with the input unit 110 at a position P1 as illustrated on the left side of FIG. 7A, the input unit 110 outputs movement amount information to the control unit 140, the movement amount information including the y-component of the movement amount from the position P1 to the position P2. When it is determined that the y-component of the movement included in the movement amount information outputted from the input unit 110 is greater than or equal to a predetermined unit movement amount, the control unit 140 moves the selection block 40 displayed in the center to the right center as illustrated on the left side and in the center of FIG. 7B based on the forward movement order information (see FIG. 6B).

Specifically, the control unit 140 moves the selection block from the position defined by the order information “1” included in the forward movement order information to the position defined by the next order information “2”.

When the processing in step S104 is completed, the control unit 140 performs the processing in step S103 again. Thus, when a sliding operation is performed continuously down to the position P3 on the input unit 110 as illustrated on the right side of FIG. 7A with the finger FG in contact with the input unit 110 at the position P2 as illustrated in the center of FIG. 7A, the input unit 110 outputs the movement amount information including the y-component of the movement amount to the control unit 140 from the position P2 to the position P3. When it is determined that the y-component of the movement amount included in the movement amount information outputted from the input unit 110 is greater than or equal to a unit movement amount, the control unit 140 similarly moves the selection block 40 displayed in the right center as illustrated in the center and on the right side of FIG. 7B. Specifically, the control unit 140 moves the selection block from the position defined by the order information “2” included in the forward movement order information (see FIG. 6B) to the position defined by the next order information “3”.

On the other hand, when it is determined that a downward sliding operation has not been performed on the input unit 110 (NO in step S103), the control unit 140 then determines whether or not an upward sliding operation has been performed on the input unit 110 (step S105). When it is determined that an upward sliding operation has been performed on the input unit 110 (YES in step S103), the control unit 140 moves the selection block 40 based on the backward movement order information (step S106). The details of the backward movement order information will be described later.

Furthermore, when it is determined that an upward sliding operation has not been performed on the input unit 110 (NO in step S105), the control unit 140 then determines whether or not a non-contact state has been detected (step S107). When it is determined that a non-contact state has not been detected (NO in step S107), the control unit 140 performs the processing in step S103 again. In other words, as long as the finger FG is in contact with the input unit 110, the control unit 140 performs the processing in steps S103, S104, or performs the processing in steps S105, S106.

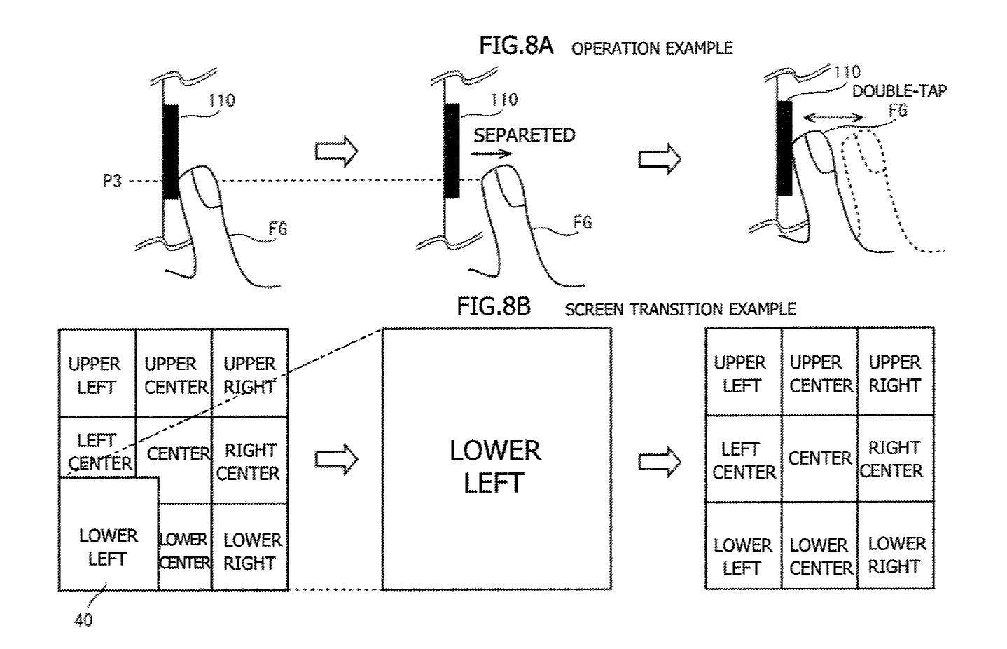

On the other hand, when it is determined that a non-contact state has been detected (YES in step S107), the control unit 140 magnifies and displays the selection block with the second magnification factor (step S108). More particularly, when the finger FG is separated and away from the input unit 110 as illustrated in the center of FIG. 8A with the finger FG in contact with the input unit 110 at a position P3 as illustrated on the left side of FIG. 8A, the control unit 140 detects a non-contact state, and determines that decision to magnify the selection block 40 has been detected. When it is determined that a non-contact state has been detected, the control unit 140 magnifies and displays the selection block 40 displayed on the lower left with the second magnification factor as illustrated on the left side and in the center of FIG. 8B.

Instead of magnifying and displaying the selection block 40 with the second magnification factor when it is determined that a non-contact state has been detected, the selection block 40 may be magnified and displayed with the second magnification factor when the control unit 140 determines that a double-tap operation has been detected after the finger FG is separated and away from the input unit 110. Thus, when a user moves the finger FG away from the input unit 110 without an intention to do so, it is possible to avoid magnifying and displaying the selection block 40 with the second magnification factor.

When the processing in step S108 is finished, the control unit 140 then stays in standby until a double-tap operation is performed on the input unit 110 (NO in step S109). When it is determined that a double-tap operation has been performed on the input unit 110 (YES in step S109), the control unit 140 displays the original screen (step S110). More particularly, when a double-tap operation is performed by the finger FG on the input unit 110 with the selection block magnified with the second magnification factor as illustrated on the right side of FIG. 8A, the control unit 140 determines that a double-tap operation is detected. When it is determined that a double-tap operation has been detected, as illustrated on the right side of FIG. 8B, the control unit 140 displays a screen which is before the start of the magnification mode and has not been magnified with the first magnification factor or the second magnification factor.

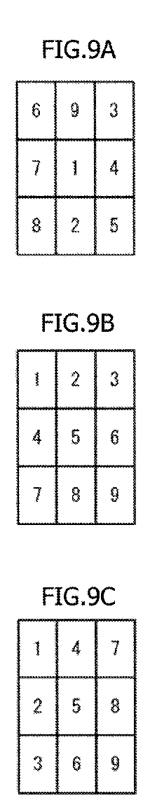

Next, another example of the above-mentioned forward movement order information will be described with reference to FIGS. 9A to 9C.

FIGS. 9A to 9C are each another example of the forward selection order information. Each forward selection order information is information to be utilized by a downward sliding operation. In the forward selection order information described with reference to FIG. 6B, the center of the multiple division blocks 30 is the starting point of movement of the selection block 40. As a downward sliding operation is performed, the selection block 40 is moved through in order of the right center, the lower left, the lower center, the lower right, the upper left, the upper center, the upper right, and the left center.

For instance, as illustrated in FIG. 9A, the movement order of the selection block 40 may be different from the movement order illustrated in FIG. 6B. Specifically, the center of the multiple division blocks 30 is the starting point of movement of the selection block 40, and as a downward sliding operation is performed, the selection block 40 may be moved through in order of the lower center, the upper right, the right center, the lower right, the upper left, the left center, the lower left, and the upper center. Particularly, the order information “1” is equidistant from the positions of order information “3” and “8” or “5” and “6” located in the corners on the diagonal, and thus the movement amount by a downward sliding operation and the movement amount by an upward sliding operation are the same until the selection block 40 is moved to a corner on the diagonal, thereby providing excellent operability. Also, as illustrated in FIG. 9B, the upper left of the multiple division blocks 30 may be the starting point of movement of the selection block 40, and as a downward sliding operation is performed, the selection block 40 may be moved through in order of the upper center, the upper right, the left center, the center, the right center, the lower left, and the lower center, and the lower right. Furthermore, as illustrated in FIG. 9C, the upper left of the multiple division blocks 30 may be the starting point of movement of the selection block 40, and as a downward sliding operation is performed, the selection block 40 may be moved through in order of the left center, the lower left, the upper center, the center, the lower center, the upper right, the right center, and the lower right.

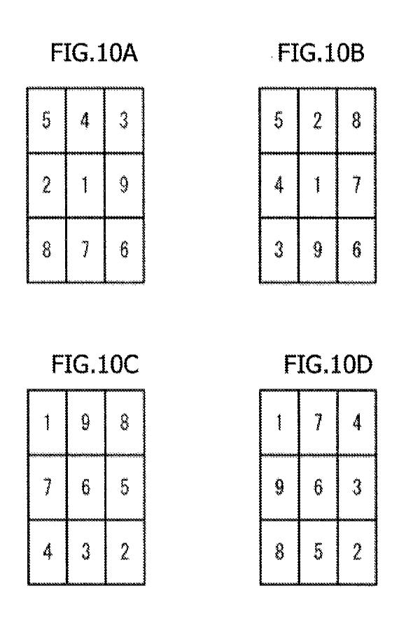

Next, an example of the backward selection order information mentioned in the processing in step S106 will be described with reference to FIGS. 10A to 10D.

FIGS. 10A to 10D are each another example of backward selection order information. Each backward selection order information is information to be utilized by an upward sliding operation. First, as illustrated in FIG. 10A, the movement order of the selection block 40 may be reverse of the movement order illustrated in FIG. 6B. Specifically, as illustrated in FIG. 10A, the center of the multiple division blocks 30 may be the starting point of movement of the selection block 40, and as an upward sliding operation is performed, the selection block 40 may be moved through in order of the left center, the upper right, the upper center, the upper left, the lower right, the lower center, the lower left, and the right center. That is, the forward selection order information illustrated in FIG. 6B and the backward selection order information illustrated in FIG. 10A make a pair.

Also, as illustrated in FIG. 10B, the movement order of the selection block 40 may be reverse of the movement order illustrated in FIG. 9A. Specifically, as illustrated in FIG. 10B, the center of the multiple division blocks 30 may be the starting point of movement of the selection block 40, and as an upward sliding operation is performed, the selection block 40 may be moved through in order of the upper center, the lower left, the left center, the upper left, the lower right, the right center, the upper right, and the lower center. That is, the forward selection order information illustrated in FIG. 9A and the backward selection order information illustrated in FIG. 10B make a pair.

Furthermore, as illustrated in FIG. 10C, the movement order of the selection block 40 may be reverse of the movement order illustrated in FIG. 9B. Specifically, as illustrated in FIG. 10C, the upper left of the multiple division blocks 30 may be the starting point of movement of the selection block 40, and as an upward sliding operation is performed, the selection block 40 may be moved through in order of the lower right, the lower center, the lower left, the right center, the center, the left center, the upper right, and the upper center. That is, the forward selection order information illustrated in FIG. 9B and the backward selection order information illustrated in FIG. 10C make a pair.

Furthermore, as illustrated in FIG. 10D, the movement order of the selection block 40 may be reverse of the movement order illustrated in FIG. 9C. Specifically, as illustrated in FIG. 10D, the upper left of the multiple division blocks 30 may be the starting point of movement of the selection block 40, and as an upward sliding operation is performed, the selection block 40 may be moved through in order of the lower right, the right center, the upper right, the lower center, the center, the upper center, the lower left, and the left center. That is, the forward selection order information illustrated in FIG. 9C and the backward selection order information illustrated in FIG. 10D make a pair.

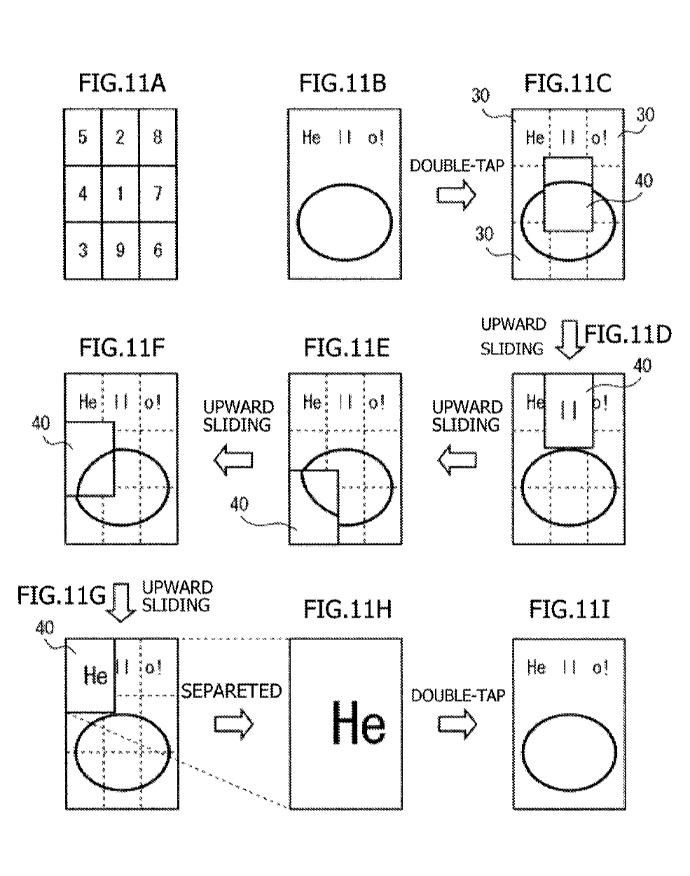

Next, the screen transition when the forward selection order information illustrated in FIG. 10B is utilized will be described with reference to FIGS. 11A to 111.

FIG. 11A is backward selection order information.

FIGS. 11B to 111 are each a screen example displayed on the display 120. The storage unit 130 stores the backward selection order information illustrated in FIG. 11A. First, as illustrated in FIG. 11B, when a double-tap operation is performed on the input unit 110 with a screen before part of the screen is magnified by the control unit 140 displayed on the display 120, the control unit 140 refers to the backward selection order information, and as illustrated in FIG. 11C, displays a screen including the selection block 40 in which the division block (not illustrated) located at the central portion of the screen is magnified and displayed with the first magnification factor which allows visual recognition of the multiple division blocks 30 located other than the central portion of the screen.

When an upward sliding operation is performed on the input unit 110 with a screen including the selection block 40 displayed, the control unit 140 refers to the backward selection order information, and continuously moves the selection block 40 through in order of the upper center, the lower left, the left center, and the upper left as illustrated in FIG. 11 D to 11G. When the finger FG is separated and away from the input unit 110, the control unit 140 detects a non-contact state between the finger FG and the input unit 110, and displays a screen, in which the selection block 40 is magnified and displayed with the second magnification factor, on the display 120 as illustrated in FIG. 11H. When a double-tap operation is performed on the input unit 110 with the screen, in which the selection block 40 is magnified and displayed with the second magnification factor, displayed on the display 120, the control unit 140 displays the original screen on display 120 as illustrated in FIG. 11I.

In the first embodiment above, the display device 100 includes the input unit 110, the display 120, and the control unit 140. The input unit 110 receives input of two-dimensional information. The display 120 displays a screen. When the control unit 140 determines that one of the multiple division blocks 30 into which the screen is two-dimensionally divided is selected based on a one-dimensional component of information received by the input unit 110, the control unit 140 magnifies and displays on the display 120 the remaining division blocks 30 from which the selection block 40 has not been selected, with the first magnification factor which allows visual recognition of the remaining division blocks 30. When the control unit 140 detects decision to magnify the selection block 40, the control unit 140 magnifies and displays the selection block 40 on the display 120 with the second magnification factor larger than the first magnification factor. Consequently, it is possible to improve the operability for designating a magnification target range.

### Second Embodiment

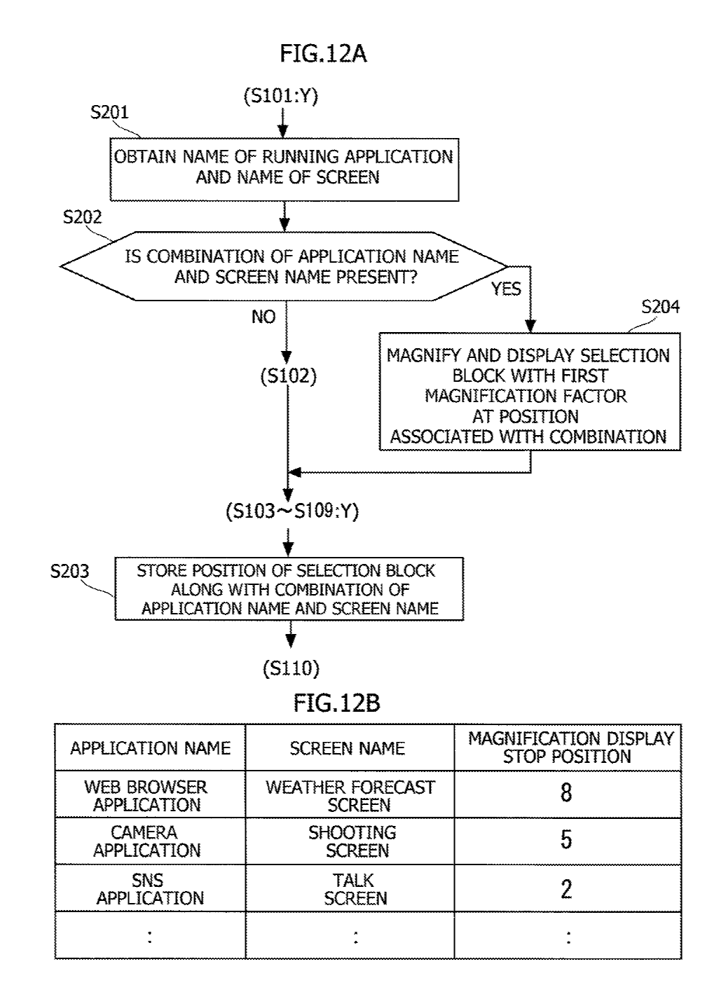

Next, a second embodiment of the present disclosure will be described with reference to FIGS. 12A and 12B. FIG. 12A is a flowchart illustrating an example operation of the display device 100. Particularly, as illustrated in FIG. 12A, in a flowchart according to the second embodiment, partial processing is added to the flowchart according to the first embodiment. FIG. 12B is an example magnification start position determination table. A magnification start position determination table is stored in the storage unit 130 described in the first embodiment.

As illustrated in FIG. 12A, in the above-described processing in step S101, when it is determined that a double-tap operation has been performed, the control unit 140 obtains the name (hereinafter referred to as the application name) of an application program (hereinafter simply referred to as an application) which is running, and the name of screen (hereinafter referred to as the screen name) (step S201). When obtaining the application name and the screen name, the control unit 140 determines whether or not a combination of the application name and the screen name is present (step S202). More particularly, the control unit 140 refers to the magnification start position determination table stored in the storage unit 130, determines whether or not a combination of the application name and the screen name is present in the table.

Here, as illustrated in FIG. 12B, the magnification start position determination table includes magnification start position determination information by which a combination of an application name and a screen name is associated with a magnification display stop position. Particularly, the magnification display stop position is a registered position of the selection block 40 when display of the selection block 40 magnified with the second magnification factor is stopped by a double-tap operation. For instance, when display of the selection block 40 magnified with the second magnification factor is stopped at the position “8”, a combination of the screen name “weather forecast screen” of a screen including the selection block 40, and the application name “Web browser application” of an application that provides the screen is registered in the magnification start position determination table along with the position “8”.

When it is determined that there is no combination of the application name and the screen name (NO in step S202), the control unit 140 performs the processing in step S102 to S109 described in the first embodiment. When a double-tap operation is detected in the processing in S109, the control unit 140 registers the position of the selection block 40 magnified and displayed along with a combination of the application name and the screen name in the magnification start position determination table (step S203). On the other hand, when it is determined that there is a combination of the application name and the screen name (YES in step S202), the control unit 140 magnifies and displays the selection block 40 with the first magnification factor at the position associated with the combination (step S204).

In this manner, according to the second embodiment, it is possible for a user to manage the tendency of the position of the selection block 40 magnified and displayed with the second magnification factor, and to quickly magnify and display the selection block 40 according to the preference of the user.

Although a preferable embodiment of the present disclosure has been described in detail, the present disclosure is not limited to the specific embodiment, and various modifications and changes are possible within a scope of the gist of the present disclosure described in the Claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A display device comprising:
an input unit that receives input of two-dimensional information;
a display that displays a screen; and
a control unit that, when determining that one of a plurality of blocks into which the screen is two-dimensionally divided is selected based on a one-dimensional component of the information received by the input unit, magnifies and displays the selected block on the display with a first magnification factor which allows visual recognition of remaining blocks none of which has been selected, and
when detecting decision to magnify the selected block, magnifies and displays the selected block on the display with a second magnification factor larger than the first magnification factor.

2. The display device according to claim 1,
wherein the input unit is a fingerprint sensor.

3. The display device according to claim 1,
wherein a direction in which information is inputted to the input unit is different from a direction that defines an order of the plurality of blocks to be formed until one of the plurality of blocks is selected based on the one-dimensional component.

4. The display device according to claim 1,
wherein a direction in which information is inputted to the input unit coincides in part with a direction that defines an order of the plurality of blocks to be formed until one of the plurality of blocks is selected based on the one-dimensional component.

5. The display device according to claim 1,
wherein when a first image generated based on information received by the input unit corresponds to a second image generated based on information received by the input unit at a different timing, the control unit changes one of the plurality of blocks to a selectable state.

6. The display device according to claim 1,
wherein a starting point of an order of the plurality of blocks formed until one of the plurality of blocks is selected based on the one-dimensional component is equidistant from blocks located at corners on diagonals on the screen.

7. The display device according to claim 1, further comprising:
a storage unit that stores a position of a block magnified and displayed with the second magnification factor in association with a combination of a name of the screen and a name of an application that provides the screen,
wherein when a combination of a name of a running application and a name of a screen provided by the running application matches the combination of the name of the application and the name of the screen stored in the storage unit, the control unit displays a block magnified with the first magnification factor at the position stored in the storage unit.

8. A display control method executed by a computer, the method comprising:
when it is determined that one of a plurality of blocks, into which a screen displayed by a display is two-dimensionally divided, is selected based on a one-dimensional component of two-dimensional information received by an input unit, magnifying and displaying the selected block on the display with a first magnification factor which allows visual recognition of remaining blocks none of which has been selected; and
when decision to magnify the selected block is detected, magnifying and displaying the selected block on the display with a second magnification factor larger than the first magnification factor.

9. The display control method according to claim 8,
wherein the input unit is a fingerprint sensor.

10. The display control method according to claim 8,
wherein a direction in which information is inputted to the input unit is different from a direction that defines an order of the plurality of blocks to be formed until one of the plurality of blocks is selected based on the one-dimensional component.

11. The display control method according to claim 8,
wherein a direction in which information is inputted to the input unit coincides in part with a direction that defines an order of the plurality of blocks to be formed until one of the plurality of blocks is selected based on the one-dimensional component.

12. The display control method according to claim 8, further comprising
when a first image generated based on information received by the input unit corresponds to a second image generated based on information received by the input unit at a different timing, changing one of the plurality of blocks to a selectable state.

13. The display control method according to claim 8,
wherein a starting point of an order of the plurality of blocks formed until one of the plurality of blocks is selected based on the one-dimensional component is equidistant from blocks located at corners on diagonals on the screen.

14. The display control method according to claim 8,
wherein the computer is connected to a storage unit that stores a position of a block magnified and displayed with the second magnification factor in association with a combination of a name of the screen and a name of an application that provides the screen, and
the display control method further comprises when a combination of a name of a running application and a name of a screen provided by the running application matches the combination of the name of the application and the name of the screen stored in the storage unit, displaying a block magnified with the first magnification factor at the position stored in the storage unit.

15. A non-transitory computer-readable recording medium having stored therein a display control program of a display device including a processor, the display control program to cause the processor to perform:
when it is determined that one of a plurality of blocks, into which a screen displayed by a display is two-dimensionally divided, is selected based on a one-dimensional component of two-dimensional information received by an input unit, magnifying and displaying the selected block on the display with a first magnification factor which allows visual recognition of remaining blocks none of which has been selected; and
when decision to magnify the selected block is detected, magnifying and displaying the selected block on the display with a second magnification factor larger than the first magnification factor.
